(19) United States
(12) Patent Application Publication
(10) Pub. No.: US 2016/0081883 A1
(43) Pub. Date: Mar. 24, 2016

(54) MEDICATION CASSETTE AND DISPENSING TRACKING APPARATUS

(71) Applicant: Leon SALTSOV, THORNHILL, ON (CA)

(72) Inventor: Leon SALTSOV, THORNHILL, ON (CA)

(21) Appl. No.: 14/399,747

(22) PCT Filed: Jun. 23, 2014
(86) PCT No.: PCT/CA2014/000516

§ 371 Date: Nov. 7, 2014

(30) Foreign Application Priority Data
Jun. 25, 2013 (CA) 2820260

(51) Int. Cl. A61J 7/00; G07F 17/00; A61J 7/04

(52) U.S. Cl. CPC A61J 7/0084; A61J 7/0481; G07F 17/0092; A61J 2205/60; A61J 7/0418; A61J 7/0454; A61J 7/0463

(57) ABSTRACT

A medication cassette according to the present invention includes a rotatable medication drum located between front and rear covers. The medication drum has a series of outwardly opening medication receiving cells and the front cover and the rear cover cooperate with the medication drum to close the cells. Each cell in cooperation with the covers defines a normally closed medication receiving pocket. The medication drum further includes an accessible drive arrangement for rotating the medication drum relative to the front and rear covers past a dispensing port. Medication in a cell aligned with the dispensing port passes therethrough in a dispensing step. The cassette further includes an alignment arrangement that releasably holds the medication drum against rotation until rotated by drive arrangement. Preferably this drive arrangement is a drive ring generally coaxial with a rotary axis of the medication drum. The medication cassette is cost effective to manufacture, provides security and is advantageously used with an automated dispensing apparatus.

### FIELD OF THE INVENTION

The present application is directed to medication cassettes used to assist in the automated or controlled dispensing of medication. The invention is also directed to apparatus for receiving such medication cassettes and dispensing the medication therein.

### BACKGROUND OF THE INVENTION

With continued advancement of health care treatment including medications, the number and diversity of medications taken by individuals continues to increase and become more complex. Each individual medication is typically sold prepackaged and/or contained in its own separate container with specific instructions for a user regarding the particular dosage and instructions regarding prescribed times for taking of the medication. This type of arrangement is satisfactory for an individual taking a particular medication for a short period of time, however it is not well suited to applications where the individual is taking several medications for the forseeable future.

With the aging population, problems associated with the incorrect taking of medication continue to increase and can represent a serious health risk to the individual.

There remains a need for a cassette for effective dispensing of medication as well as a system that allows medication from different cassettes to be selectively dispensed in accordance with a predetermined regime.

The present invention seeks to address a number of these issues.

### SUMMARY OF THE INVENTION

A medication cassette according to the present invention comprises a front facing cover, a rotatable medication drum and a rear cover. The medication drum includes a series of outwardly opening medication receiving cells. The front facing cover and the rear cover cooperate with the medication drum to close the cells such that each cell in cooperation with the covers defines a normally closed medication receiving pocket. The medication drum further includes a drive arrangement exteriorly accessible for rotating the medication drum within the front facing cover past a dispensing port through which medication in a cell aligned with the dispensing port can pass and be dispensed. The cassette further includes an alignment arrangement that holds the medication drum against rotation in an aligned position until rotated by the drive arrangement.

In an aspect of the invention, the drive arrangement is a drive ring generally coaxial with a rotary axis of the medication drum.

In a further aspect of the invention, the drive ring is generally interior to the cassette and includes an access point for engagement with a drive of a dispensing device.

According to a preferred aspect of the invention, the drive ring includes outwardly facing, drive teeth for incrementally rotating the medication drum.

According to an aspect of the invention, the alignment arrangement includes a series of aligned positions on an inwardly facing surface of the drive ring and the alignment arrangement includes a displaceable limiting member movable from an aligned position in one of the aligned positions limiting rotation of the medication drum to a position allowing rotation of the medication drum and wherein the displaceable member is biased to the aligned positions.

In a preferred embodiment of the invention, the displaceable member includes a locking surface biased by a spring arm for engagement with any one of the aligned positions.

In an aspect of the invention, the locking surface is a roller secured at an end of the spring arm and the aligned positions are a series of alignment pockets where each pocket is shaped to receive the roller and releasably maintain the medication drum in one of the aligned positions.

In yet a further aspect of the invention, each alignment pocket includes cam surfaces on either side thereof linking the pocket with an adjacent pocket; and wherein the cam surfaces allow rotation of the medication drum in either direction and assist in alignment of the medication drum with a dispensing outlet in the cover.

In a preferred aspect of the invention, each of the medication receiving cells is open at an outer radial end thereof.

According to a preferred aspect of the invention, the cassette includes a light reflecting surface associated with each cell disposed to reflect light and direct the reflected light through the respective cell and wherein each cell and the cassette allow reflected light to pass out of the cell and the cassette through a radial end of each cell. Preferably, the light reflecting surface is conical and has an angle of approximately 45° relative to the cells and the light reflecting surface is part of the rear cover.

In an aspect of the invention, the drive ring projects outwardly from a side of the medication drum and the front cover includes a U shaped recess for covering the drive ring.

In a further aspect of the invention, the alignment arrangement includes a series of alignment positions on an inwardly facing surface of a drive ring of the medication drum. The alignment arrangement includes a displaceable member movable from an aligned position to a position allowing rotation of the medication drum. The displaceable member is biased to the aligned position and the displaceable member includes a locking surface biased by a spring arm for engagement with any one of the series of alignment positions.

### BRIEF DESCRIPTION OF THE DRAWINGS

Preferred embodiments of the invention are shown in the drawings, wherein:

FIG. 1 is a perspective view of the dispensing apparatus about to receive a medication cassette;

FIG. 2 is a partial cut away of the dispensing apparatus;

FIG. 3 is a perspective view of the medication cassette;

FIG. 3a is a sectional view taken along plane a-a of FIG. 3;

FIG. 3b is a sectional view taken along plane b-b of FIG. 3;

FIG. 4 is an exploded perspective view of the medication cassette;

FIG. 4a is a partial enlargement of a lower portion of the medication cassette;

FIG. 5 is a perspective view of the medication drum;

FIG. 5a is a partial view showing a portion of the drive track of the storage drum;

FIG. 6 shows additional details of the medication cassette;

FIGS. 7.1 and 7.2 show details of the drive of the medication drum within the cassette;

FIGS. 7.3, 7.4 and 7.5 show additional details of the drive of the medication drum and the dispensing of a pill;

FIG. 8 is a partial sectional view through the dispensing apparatus showing the loading of a cassette;

FIG. 9 is a partial perspective view showing the loading of a cassette where a series of cassettes have been loaded on the drive shaft;

FIG. 10 is a partial cut away view showing six cassettes loaded on the drive shaft;

FIG. 11 is a partial perspective view showing details of a movable carriage;

FIG. 12 is a partial top view showing the discharge of a container of dispensed medication exiting the dispensing apparatus;

FIG. 13 shows additional details of the relationship between the movable carriage and the medication cassettes;

FIG. 14 shows additional details of the drive mechanism for the medication cassette;

FIG. 15 is a sectional view showing details of the light sensing arrangement for determining whether a pill is in the cavity of the dispensing drum;

FIG. 16 shows the relationship between the cassette dispensing a pill and the carriage with the medication collecting vessel and the sensing of medication as it is dispensed;

FIG. 17 is a perspective view showing the dispensing apparatus with the dispensing vessel ejected to one side allowing removal of the vessel by the user;

FIG. 18 is a rear perspective view showing the medication vessel returned to an in use position;

FIG. 19 is a perspective view of the dispensing apparatus inverted for loading medication into cassettes;

FIG. 20 is a partial perspective view illustrating the movable carriage and cassettes cooperating for loading cassettes;

FIG. 21 is a cutaway perspective view of the movable carriage, loading funnel and medication cassette cooperating for loading of medication;

FIG. 22 is a sectional view taken along plane A-A of FIG. 21;

FIG. 23 is a partial sectional view taken along plane B-B of FIG. 21; and

FIG. 24 is a perspective view of the movable carriage about to receive the loading funnel.

### DETAILED DESCRIPTION OF THE PREFERRED EMBODIMENTS

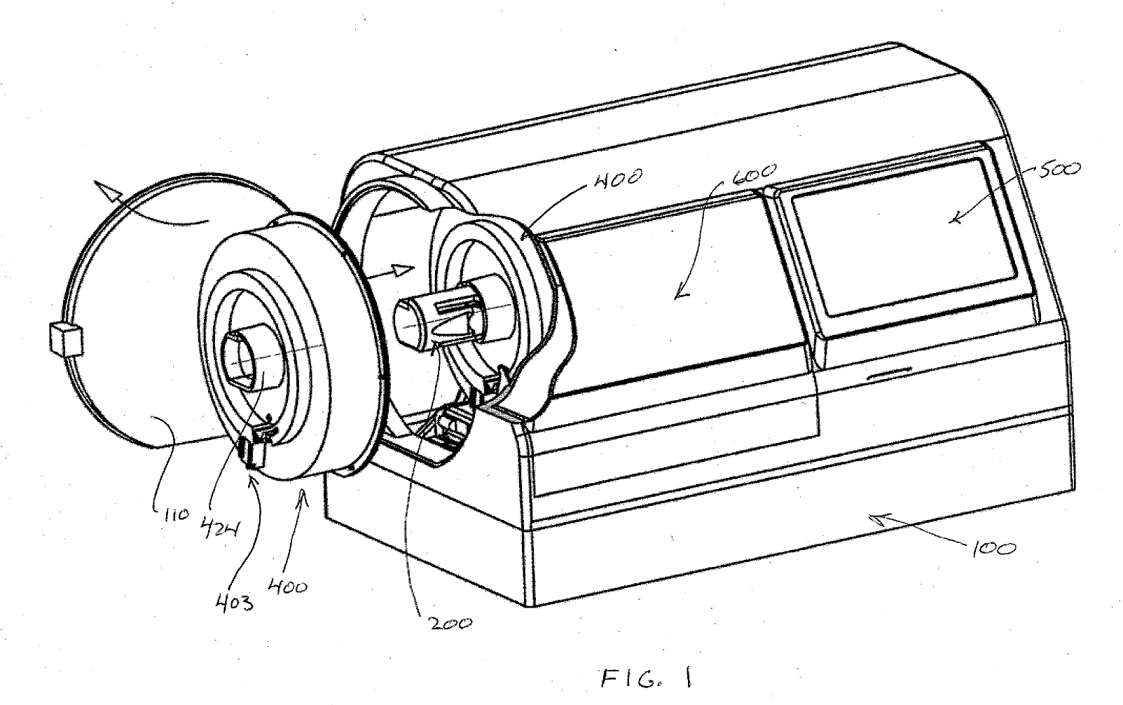

The dispensing apparatus shown as 100 in FIG. 1 is designed to allow loading and unloading of a series of medication cassettes generally shown as 400. These medication cassettes can only be loaded on the drive shaft 200 in one orientation. The dispensing apparatus 100 also includes a display screen 500 to provide user instructions regarding the dispensing of medication and/or operation of the dispensing apparatus. It will also display different report or summary information for use by the user and/or medical personnel. The apparatus 100 preferably includes an analyzing arrangement generally shown as 600 for receiving test results or sensed conditions of the user. For example the apparatus is connectable to a blood pressure monitor for receiving results of blood pressure testing and recording thereof with date and time information.

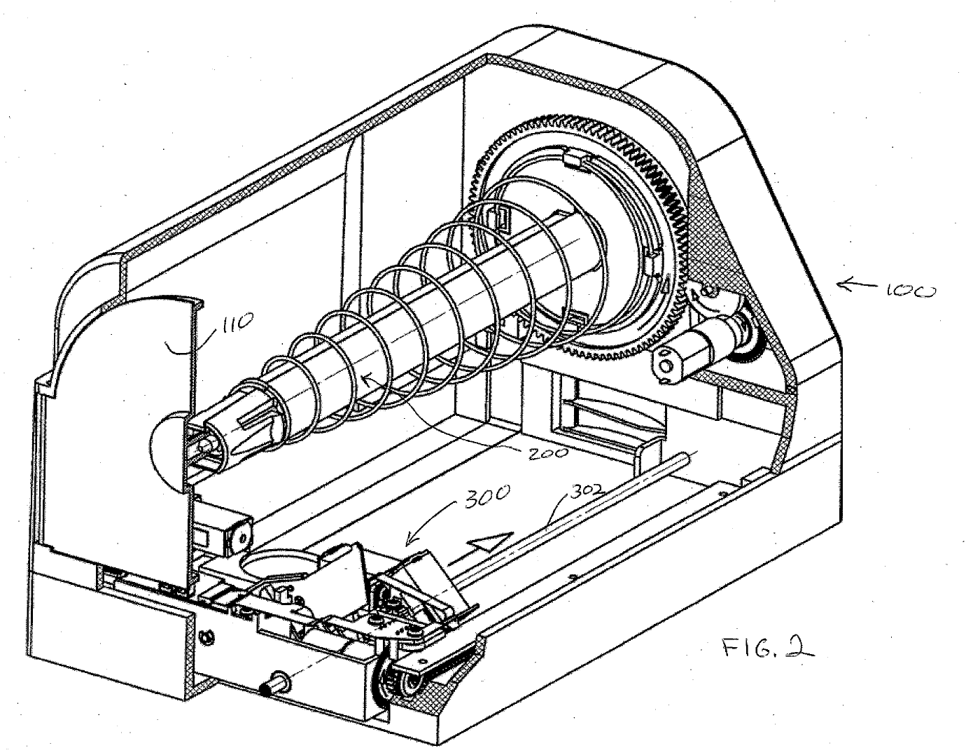

The apparatus can also connect to other devices, for example a blood analyzing device that measures a particular condition sought to be monitored and recorded. This information is preferably stored in the unit in combination with other tests and dispensing information for future reference and assistance in assessing a user's condition over time. These aspects are described in detail in Applicant's previous U.S. patent application Ser. No. 12/998,617 now U.S. Pat. No. 8,333,281 incorporated herein by reference. The dispensing apparatus 100 includes a cover 110 shown in the open position in FIG. 1. Once a desired group of cassettes 400 are loaded onto the drive shaft 200, the cover 110 is moved to a closed position as partially shown in FIG. 2. As will be described an automated procedure will confirm the identity and medication contained within the cassettes.

The dispensing apparatus 100 also includes movable carriage 300 locatable below any of the medication cassettes loaded on the drive shaft. The movable carriage 300 travels below the cassettes and is alignable with a lower dispensing portion 403 of each cassette 400.

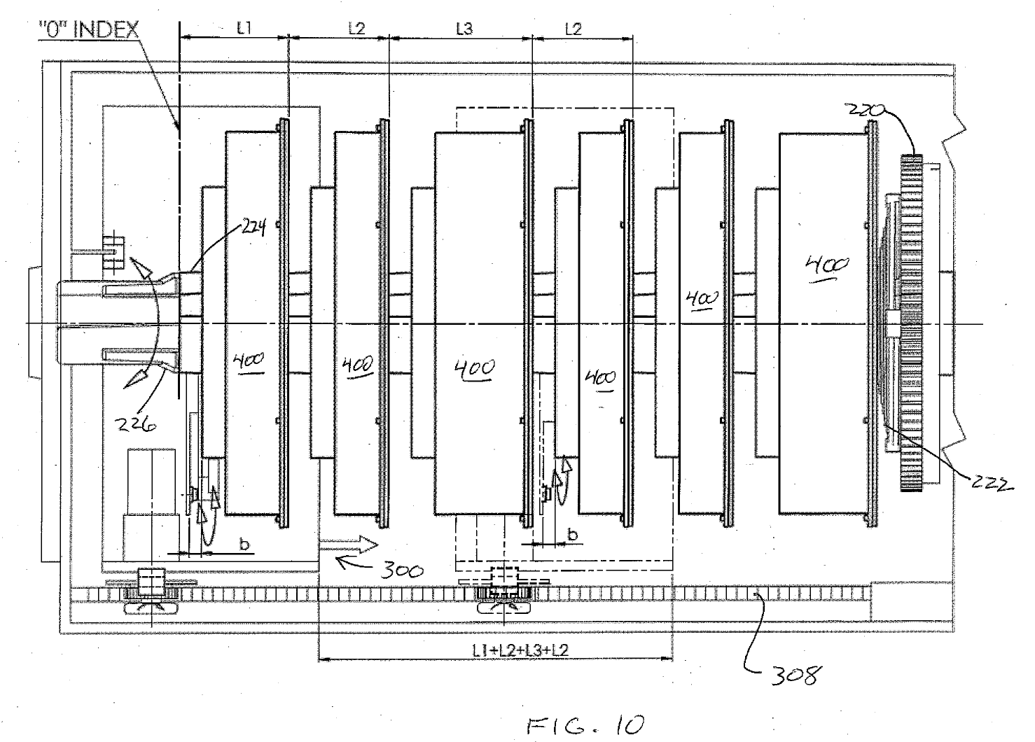

This arrangement allows a medication drum within a cassette to be moved to an aligned position to allow dispensing of a pill into a receiving medication container provided on the movable carriage. The controlled movement of the carriage 300 beneath and alignable with the cassettes provides a compact device that may be used by two or more users. For example, as shown in the sectional view of FIG. 10, six different cassettes 400 have been loaded into the dispensing apparatus 100. The carriage 300 is movable below the cassettes for alignment therewith for dispensing medication. This ability to store a series of different cassettes where all the cassettes are available for dispensing is highly desirable.

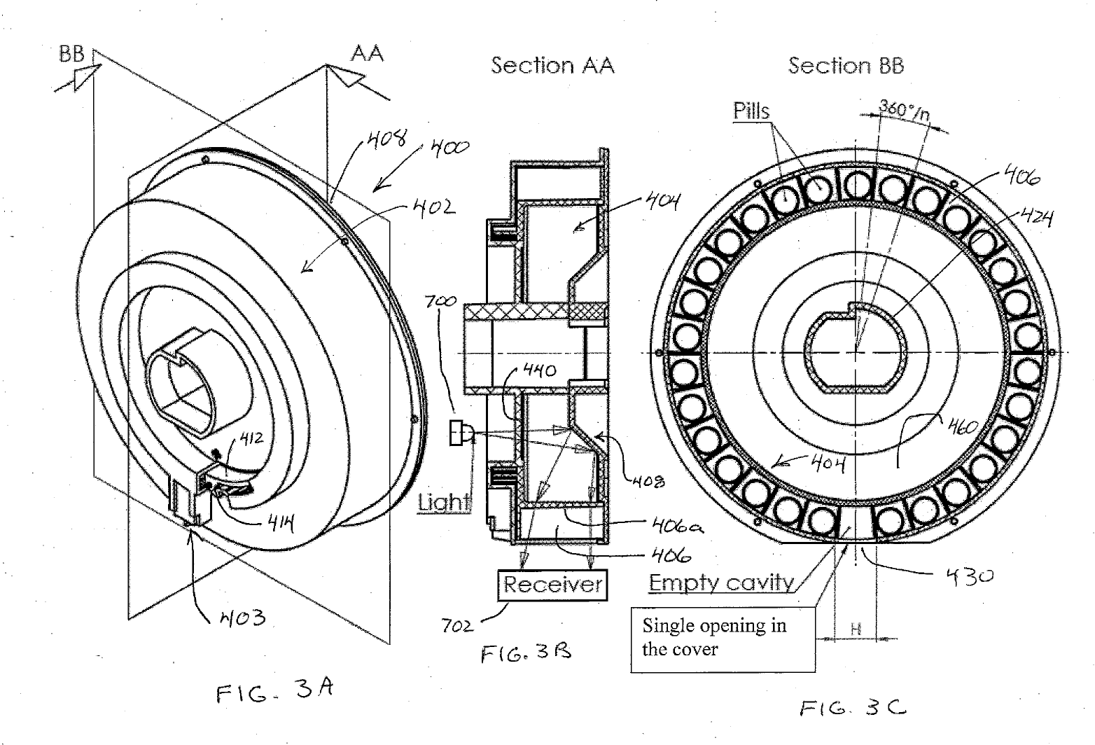

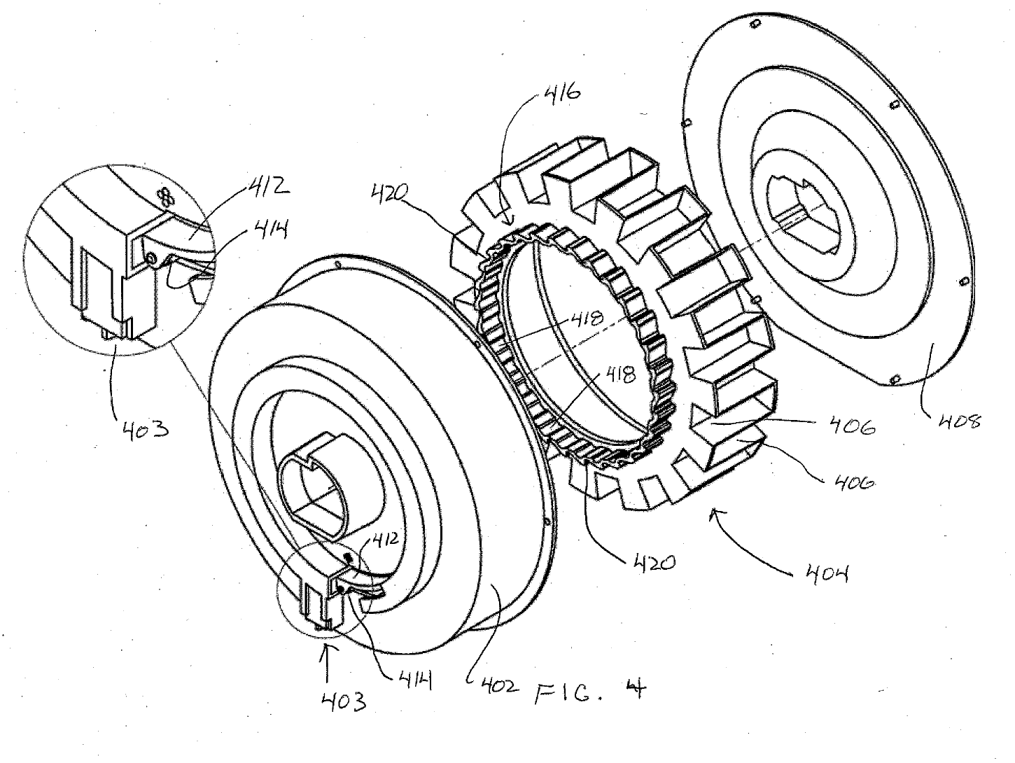

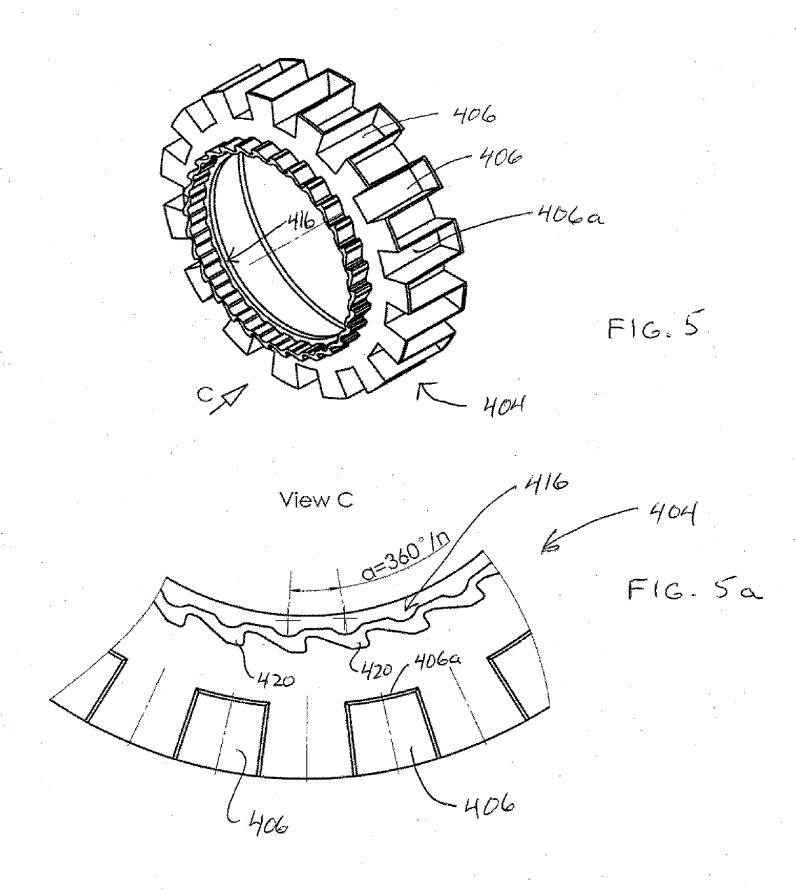

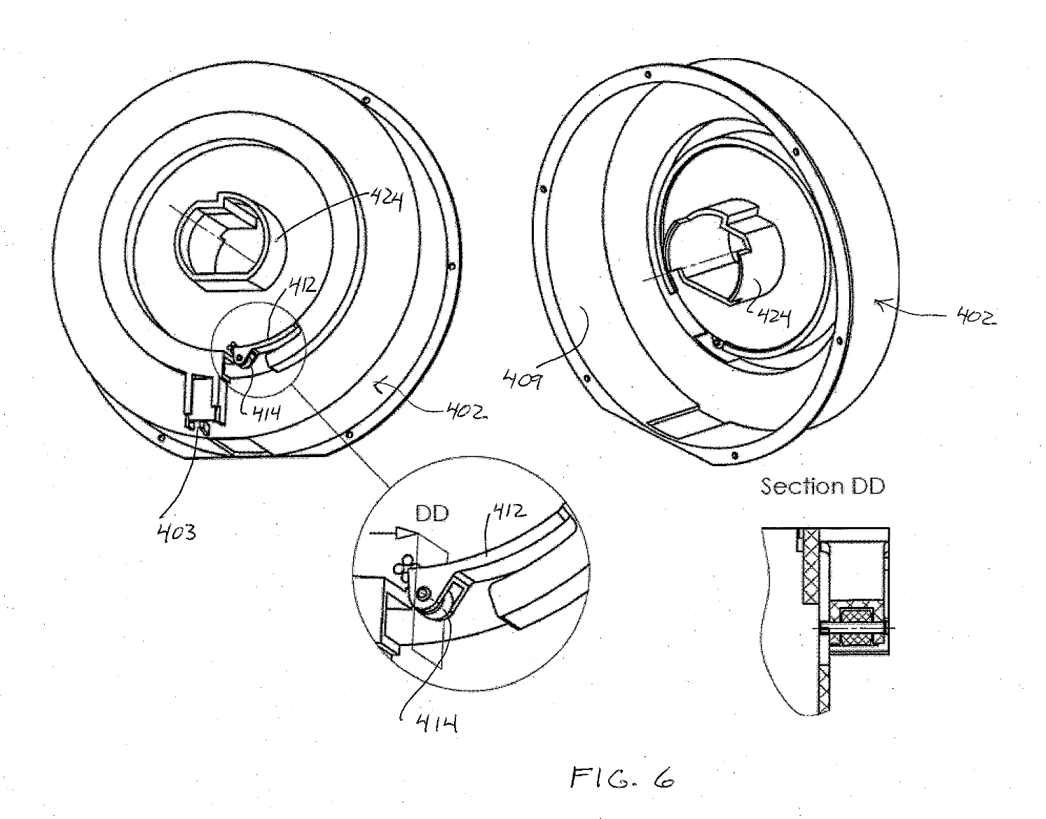

To fully appreciate the versatility of the dispensing apparatus it is important to consider the structure of the medication cassette 400 shown in FIGS. 3 through 7. The medication cassette 400 includes a front cover 402 that receives the rotatable medication drum 404. The medication drum has a series of open ended medication cells 406 for receiving individual pills. The actual cell size 406 can vary according to the type of medication to be dispensed and different sizes of medication cassettes can be used as illustrated in FIG. 10. The medication drum 404 is selectively rotatable within the front cover 402. A rear cover 408 effectively captures the medication drum within the medication cassette 400.

It is desirable that the medication drum is selectively rotatable within the front cover 402. The front cover includes a downwardly directed spring arm 412 with a stop portion 414 provided at the end of the spring arm. This stop portion engages the inner surface of ring 416 that has a series of alignment pockets 418. Ring 416 on an outer surface thereof includes a series of ratchet teeth 420 which will engage with a drive member for selectively rotating the medication drum 404 within the front cover 402.

Basically the drive arrangement, as will be subsequently explained, indexes the medication drum and the various alignment pockets 418 in combination with the stop portion 414 of the spring arm align the medication drum with the front cover 402 in one of the alignment positions. The front cover 402 and the rear cover 408 of the medication cassette rotate with rotation of the drive shaft 202. There is no ability for these components to rotate independent of the drive shaft as each component includes key surfaces provided thereon that engage with the drive shaft. In contrast, the medication drum 404 can be rotated within the front cover 402 independent of the drive shaft (used to dispense medication) and can also rotate with rotation of the drive shaft 200 (used to determine cassette contents).

When a medication cassette is loaded and before a dispensing operation, a cassette audit procedure confirms the particular content and location of the pills within each cassette. For example, in many situations all of the cells of the cassette are not initially filled as the number of pills to be dispensed is less than the number of cells available in the cassette. The dispensing apparatus after loading of any cassette and before dispensing medication rotates the drive shaft and thereby rotates the medication cassettes. This audit procedure starts with the first cassette at the free end of the drive shaft. The carriage is moved to allow scanning of the first cassette adjacent the free end of the shaft to determine the cassette type (number of cells and width of the cassette), the user, the medication, the quantity of the medication and the dosage regime.

This type of information is preferably provided electronically or in a readable form on the medication cassette itself, for example by means of a RFID tag, bar readable code or other type of information. In the preferred embodiment as described, a RFID tag provides details of the medication, the size or type of the cassette and the amount of medication provided in the particular cells thereof. Furthermore individual dosages of the medication are loaded in particular cells and preferably in a consistent manner. Preferably, the medication cassette includes a zero cell or an index point and this is typically where an initial medication dosage is located followed by dosages being loaded in a series of subsequent cells.

The cassette type provides the width of the cassette and this information allows the carriage to move to the gap between the first and second cassette for scanning of the contents thereof. Knowledge of the second cassette type allows for carriage positioning between the second and third cassette.

The cross-section of the cassette shown in FIG. 3b provides details of the particular cooperation between the front cover 402, the rear cover 408 and the individual cells 406 of the medication drum 404. The base 406a of each cell 406 is preferably translucent or at least allows the passage of a sensing radiation (such as infrared radiation) emitted by the light 700. The emitted radiation passes through the panel 440 of the front cover and strikes the angled reflecting surface 460 of the rear cover. Due to the angled surface the radiation passes downwardly through the base 406a of the cell 406 and if not interrupted, the radiation is received by the receiver 702 after passing through side wall 409 of cover 402.

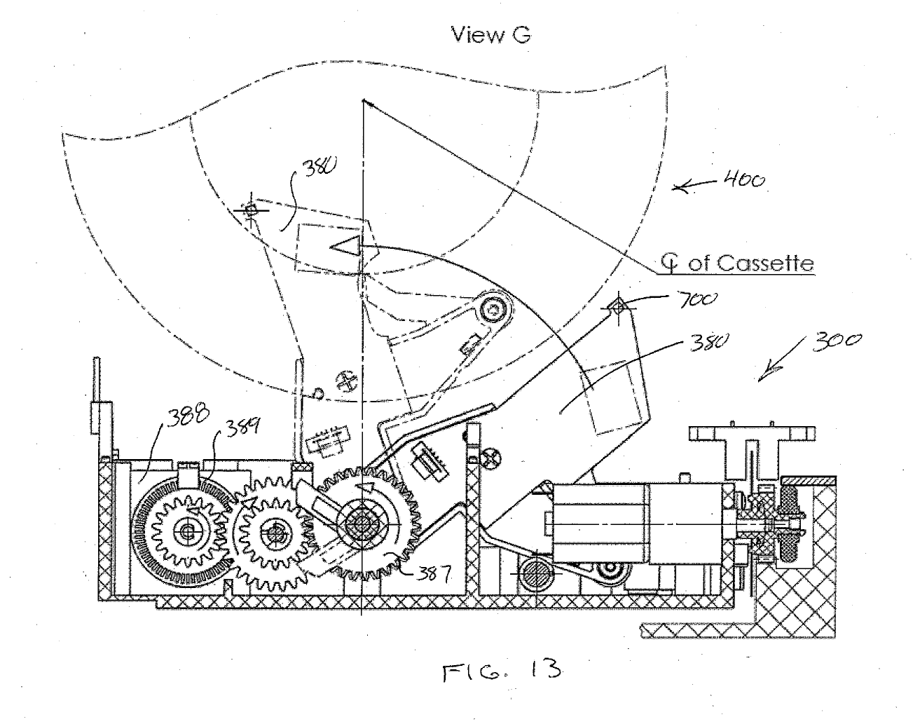

If a pill is present in the individual cell 406 the amount of light (radiation) received by the light receiver 702 is significantly reduced and this reduction in sensed light indicates a pill is present. The light emitter 700 is located on the displaceable arm 380 which is moved into a sensing position as shown in FIG. 13 each time the contents of a cassette are sensed. The light receiver 702 is in a stationary position on the carriage. Rotation of the medication drum within the front and rear covers allows each of the individual cells 406 of the medication drum to be assessed to determine whether a particular medication is present. These results are tracked and the particular cells of the medication cassette having medication are maintained in memory to allow the appropriate dispensing thereof in accordance with a dispensing regime preferably provided by the RFID tag. Other arrangements for determining the particulars of the medication associated with a cassette and the transfer thereof to the apparatus can be used, however the RFID tag is a preferred embodiment.

As part of an initial setup procedure whenever a cassette is loaded into the dispensing apparatus, the dispensing regime and the particulars of all loaded cassettes are confirmed, for example, by the RFID tag and the sensed medication. Tracking of the cassettes allows the apparatus to appropriately position the medication drum within the cassette in a predispensing position.

With the present medication cassette, the medication drum 404 is rotatable within the front and rear covers by a selective drive arrangement. There is also an alignment arrangement (i.e. the spring arm 412) which is used to maintain a particular registration of the medication drum until such time that it is appropriately driven to cause rotation within the covers. The medication cassette can be rotated with rotation of the drive shaft and with this rotation the medication drum, in the preferred embodiment merely rotates with the front and rear cover. The selective drive of the medication drum within the covers is carried out typically to dispense or load medication when the medication cassette is stationary and the rotary shaft is in a predetermined angular position.

The medication cassette includes an opening in the front cover and this opening is identified as 430. Medication from the medication cassette is dispensed through this opening into the vessel provided on the carrier as will be further described.

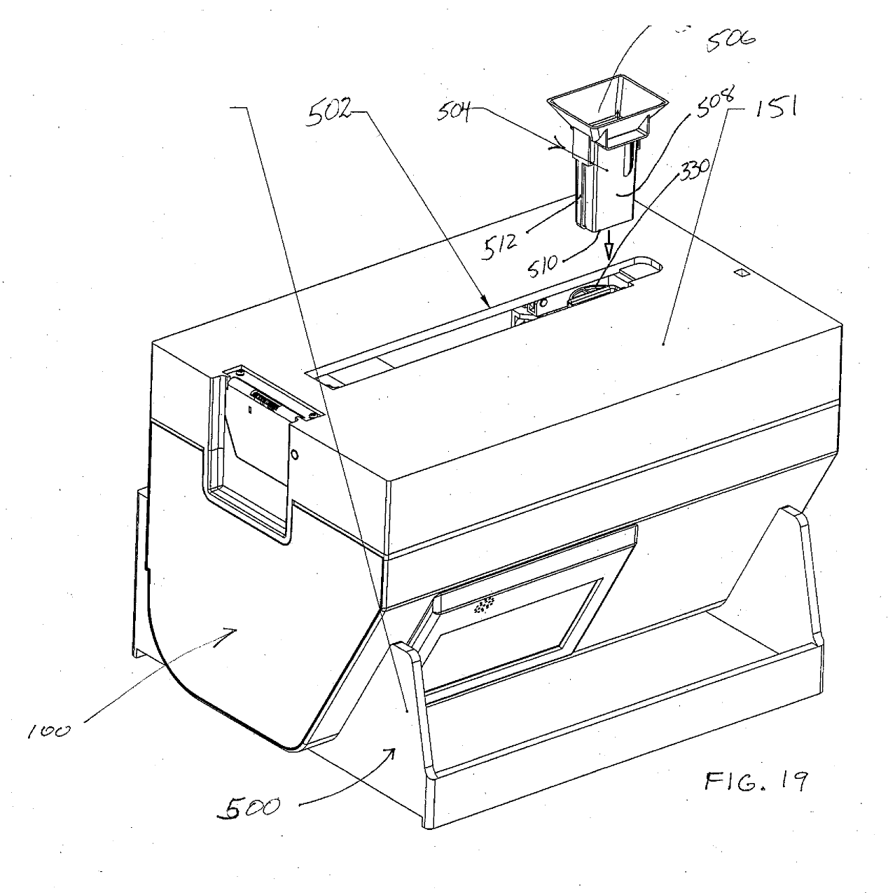

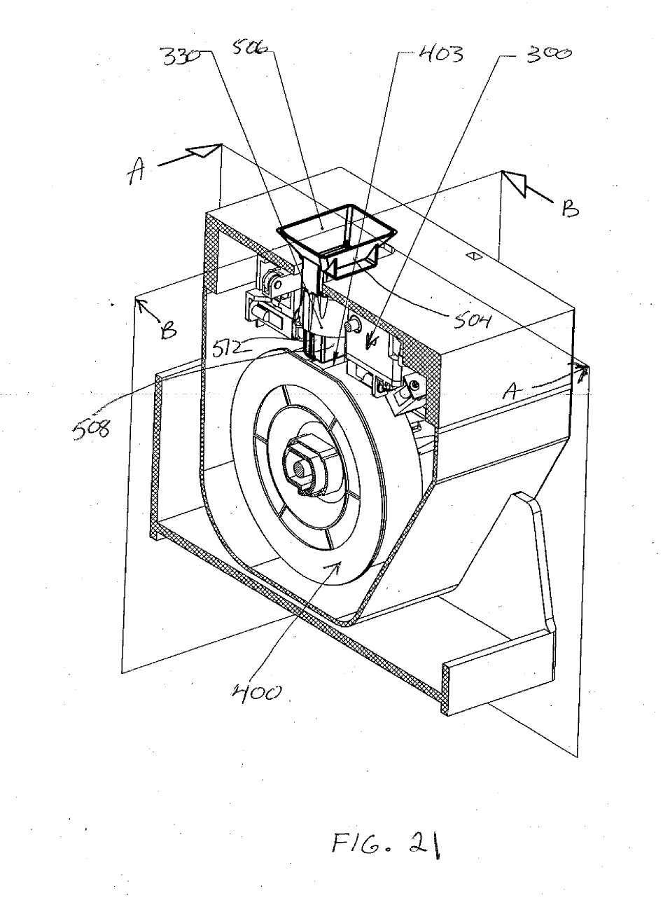

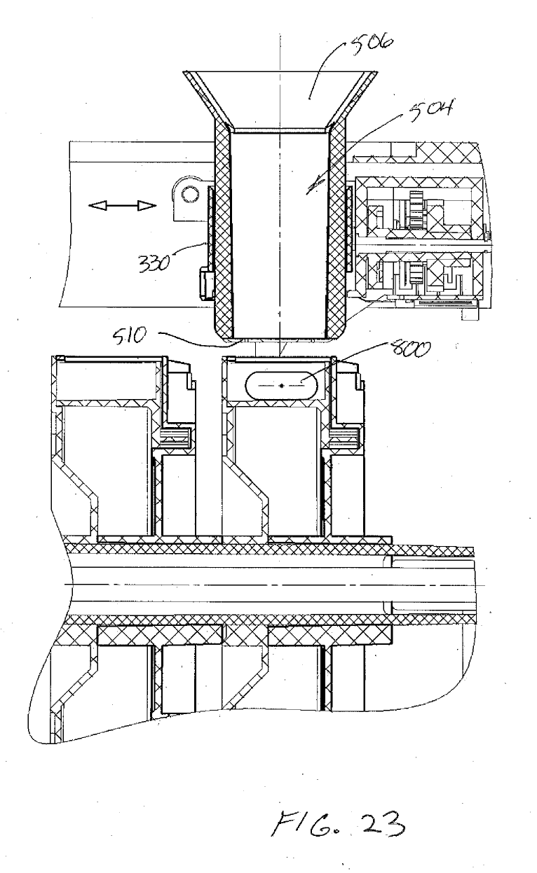

It can be appreciated that the front cover, the rear cover and the medication drum all cooperate to provide a cost effective arrangement. The cassette can be designed as a disposable package which allows automatic dispensing of the contents thereof. The cassettes can also be designed for refilling and this is described with respect to FIGS. 19 through 24.

As indicated in FIG. 10 the dispensing apparatus can receive different widths of cassettes with the cassettes preferably being a similar diameter. The number of cells within a particular cassette is variable and thus the angle of the rotation of the shaft, to sense medication within a particular cell of a cassette, is adjusted based on the particular structure of the cassette.

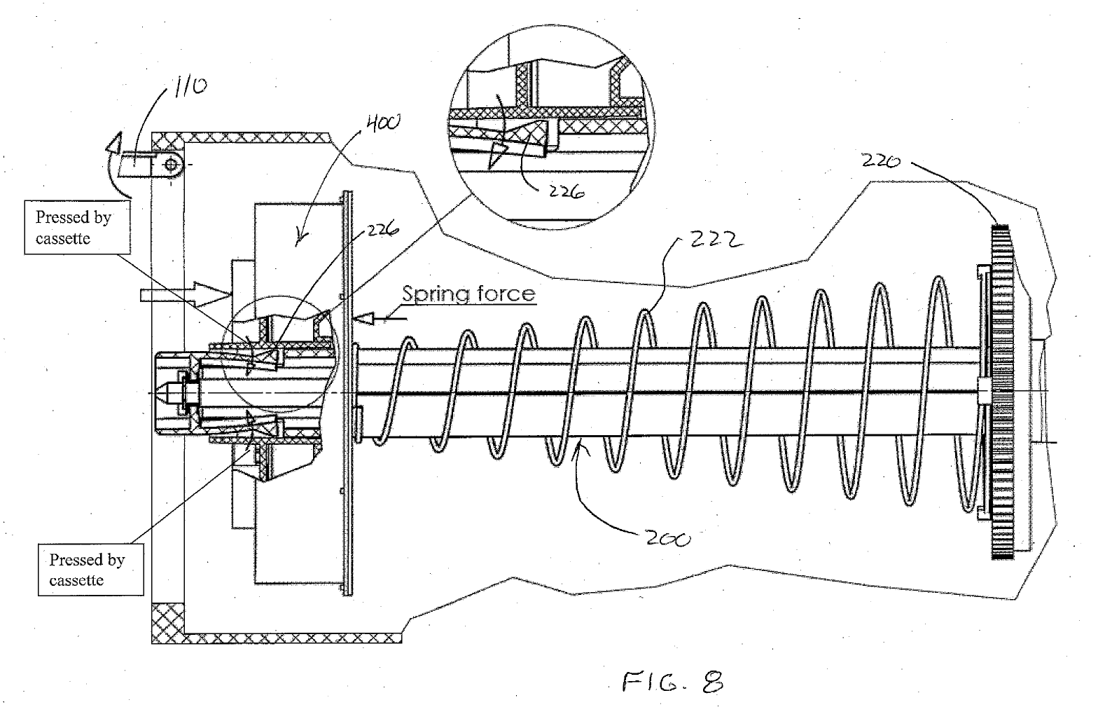

FIGS. 8, 9 and 10 show loading of the cassettes 400 on the rotary shaft 202. The rotary shaft 202 is supported at the right end of the dispensing apparatus and has a free end 204 that passes through the rotary drive port 424 of each cassette. As can be appreciated from a review of the earlier drawings, the medication cassette is inserted on the drive shaft and can only be inserted on the drive shaft in one particular orientation.

Once the cassette is loaded on the drive shaft the front and rear covers rotate with the rotation of the drive shaft. The drive shaft is controlled by the drive gear 220 provided at one end of the dispensing apparatus. The drive shaft also includes a compressible conical type spring 222 that provides a spring force on the rear of the first inserted cassette to force the cassette towards the free end 202 of the drive shaft. With this arrangement the position of the last loaded cassette is known and this simplifies the scanning of the cassettes.

When multiple cassettes are inserted on the drive shaft as shown in FIG. 10 the first inserted medication cassette is forced by the conical spring towards the free end of the drive shaft and each of the subsequently inserted medication cassettes are in contact. The last inserted medication cassette cannot pass over the free end of the drive shaft due to the spring arms 224, 226 provided on the free end of the drive shaft. These spring arms engage the rotary port 424 of the front cover of the last inserted cassette and the cassette can only be removed by compression of the spring arms 224, 226 to allow the cassette to pass over the free end of the drive shaft. In this way the cassettes, regardless of their particular width, are placed in abutment and forced towards the end of the drive shaft and are maintained on the drive shaft by the spring arms 224, 226.

As shown in FIG. 10 the width of the individual cassettes are shown as L1, L2, L3, L2 with respect to the first four cassettes. The device will effectively locate the carriage below the last loaded cassette (position known) for scanning thereof. After scanning the last loaded cassette, the carriage can move to the gap between this cassette and the abutting cassette for scanning thereof based on the detected width. This process is repeated to scan all loaded cassettes.

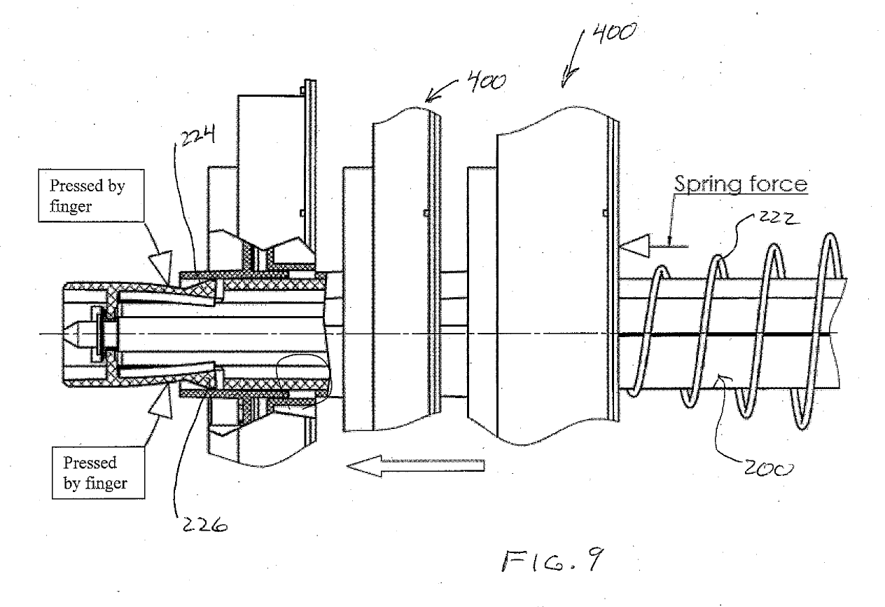

Further details of the spring arms 224, 226 are shown in FIG. 9 where a medication cassette 400a is being inserted on the drive shaft. As can be seen, the rotary port 424 has not yet passed the spring arms and the user must continue to push the cassette onto the drive shaft otherwise it will be moved to the free end of the drive shaft indicating to the user that the cassette has not been properly loaded.

FIG. 2 shows the movable carriage 300 which is movable along the fixed guide rod 302 supported either end of the dispensing apparatus. The movable carriage includes a drive motor 304 to one side of the movable carriage having a drive gear 306 in mesh with the fixed rack 308 provided in the dispensing apparatus. The drive motor 304 also includes an incremental position sensing disk 320 that is used to accurately determine the position of the carriage in the length of the guide rod 302 and the position within the dispensing apparatus. This information coupled with the scanned knowledge of the width of the loaded cassettes allows accurate alignment of the carriage for scanning and dispensing.

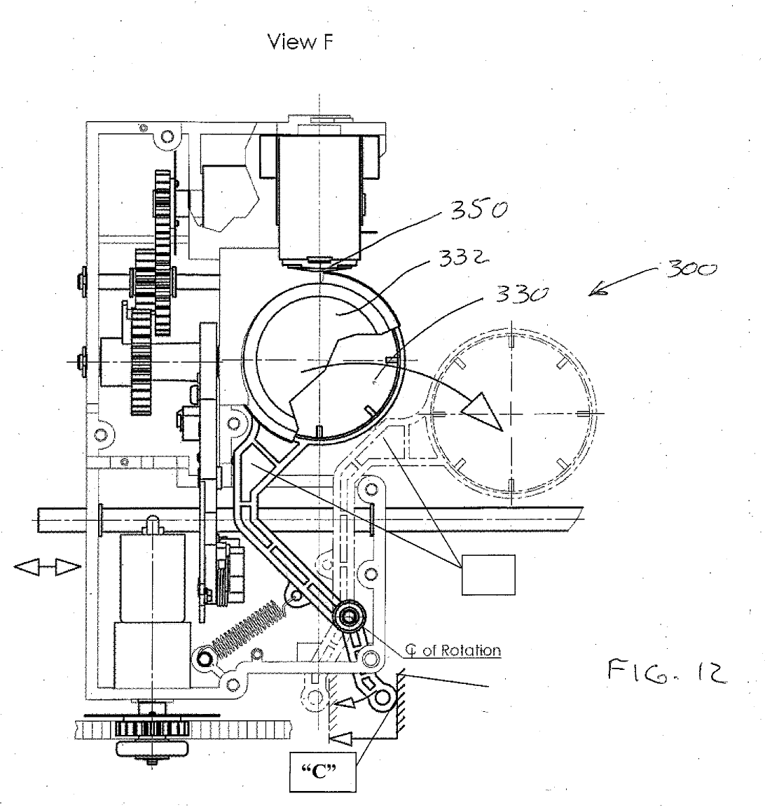

The movable carriage includes a receiving cavity 330 that preferably receives a removable medication container 332 shown in FIG. 12. Basically the removable medication container 332 is positioned below an appropriate medication cassette for receiving medication dispensed from the cassette in accordance with the particular dosage regime and time information.

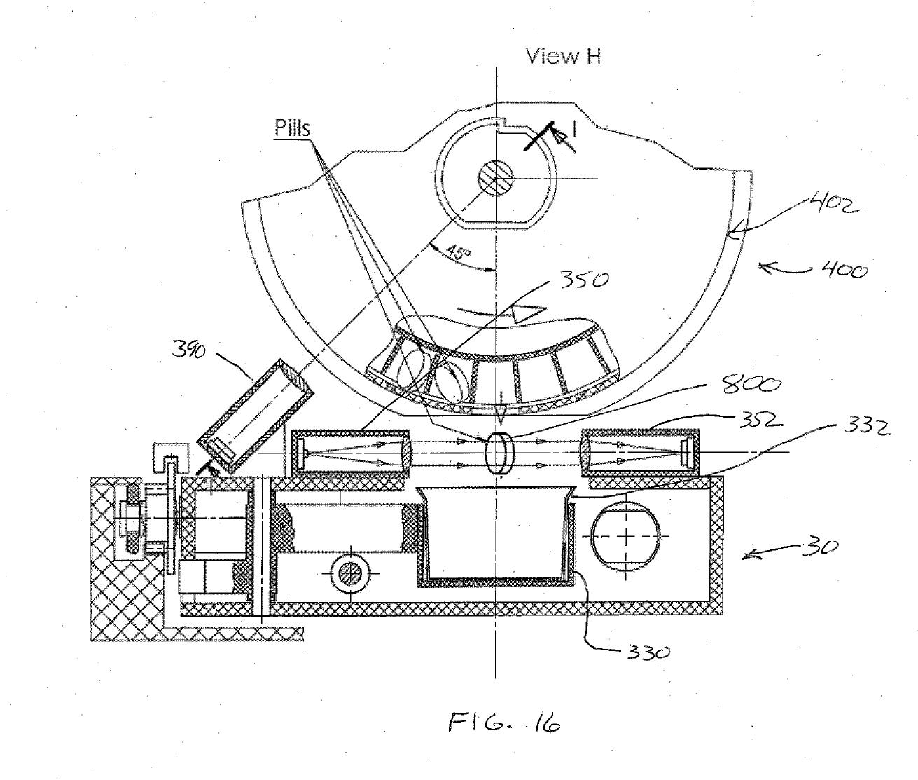

The movable carriage 300 also includes a light transmitter 350 and a light receiver 352. Each of these components move with the carriage and allow detection of medication as it passes into a medication containing vessel 332. This aspect can be appreciated from a review of FIG. 16 where the light transmitted by transmitter 350 passes over the opening above the containing vessel 332 and is received by the receiver 352. If a pill such as pill 800 is discharged from the medication cassette it interrupts the light beam. This interruption in the transmitted light is detected and the device confirms that a particular medication has been dispensed and received in the vessel 332.

One of the features of the movable carriage is the displaceable arm 380 that performs a number of functions. The displaceable arm 380 is movable to a determined position to one side of a medication cassette when positioned on the drive shaft to allow sensing of the content of the individual cells of the medication cassette. Basically the arm 380 is moved to position the light source 700 such that it overlaps the medication cassette and directs radiation through the cassette to the reflecting surface 460 of the cassette. Due to the angling of this surface, light passes through the cassette and if not interrupted (pill not present) is received by the light receiver 390 provided on the carriage.

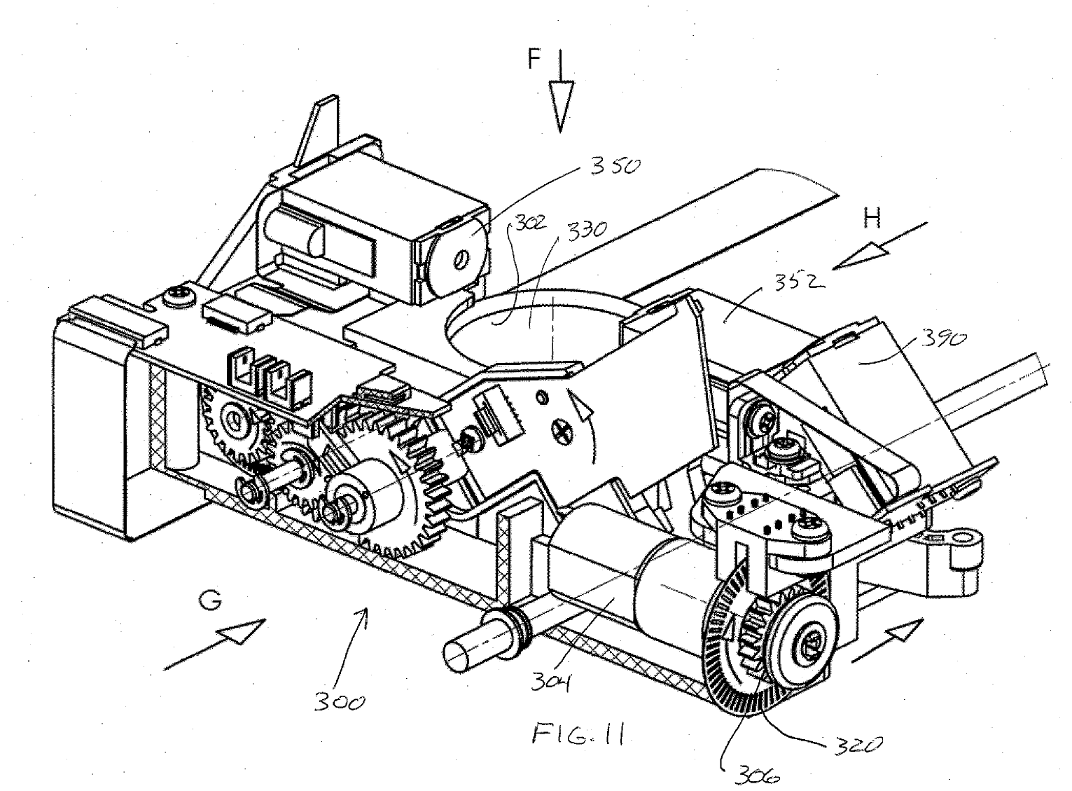

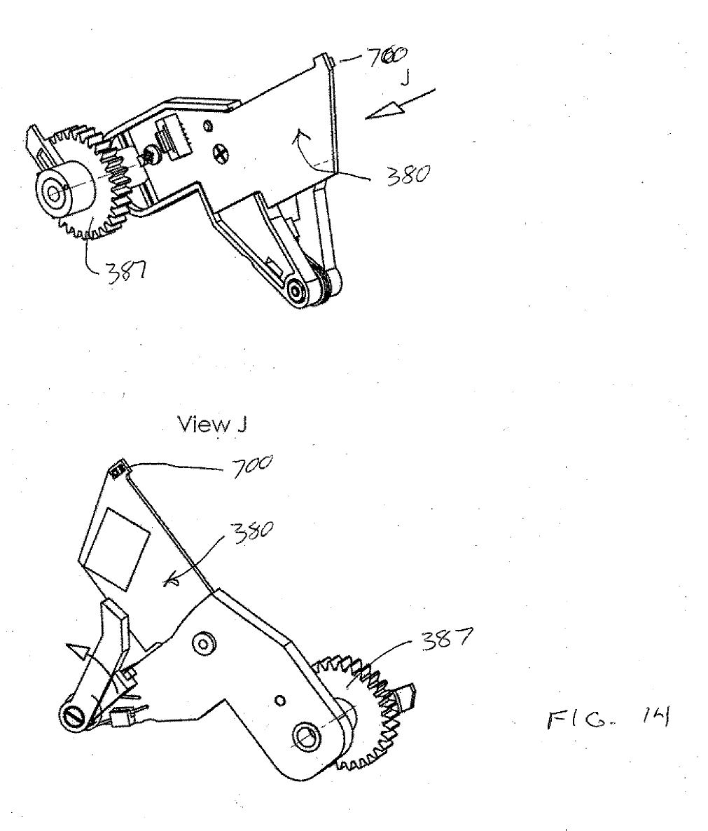

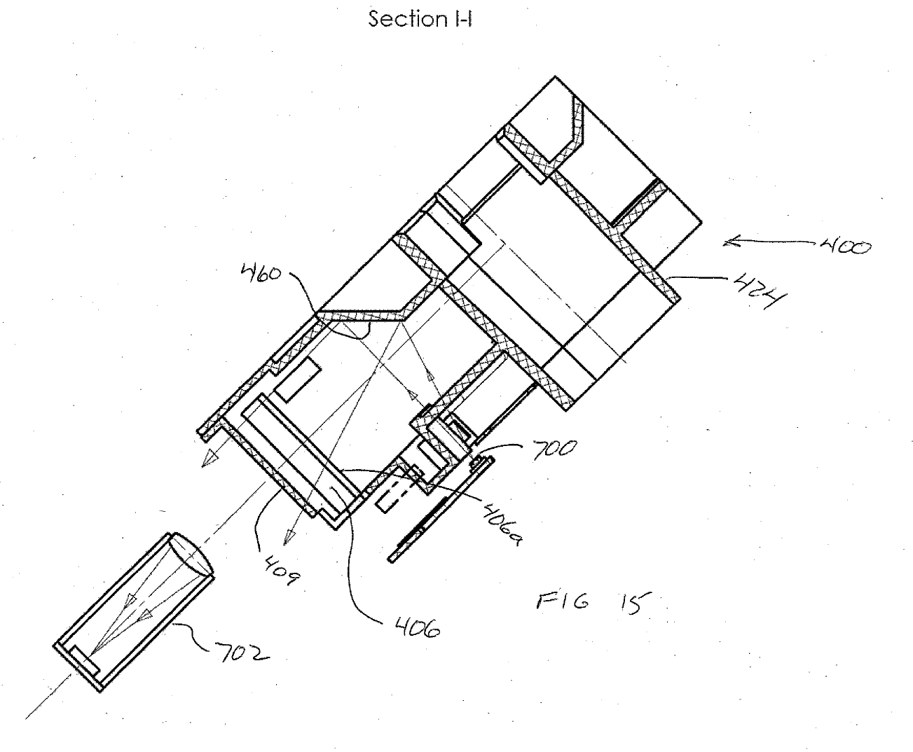

As can be seen from FIG. 11, the light receiver 390 is angled and the light passes through a particular cell to determine whether there is any medication located in the cell. The particular orientation shown places the receiver 390 at a 45° angle. The displaceable arm 380 in FIG. 14 shows the light transmitter 700. FIG. 16 shows the angulation of the light receiver 390 on the carriage.

This arrangement of the displaceable arm with the light transmitter allows a medication cassette, when loaded onto the rotary shaft, to be selectively indexed to determine which cells have medication therein. In this case, the medication cassette is rotated by the rotary shaft and the medication drum and the front and rear covers all rotate.

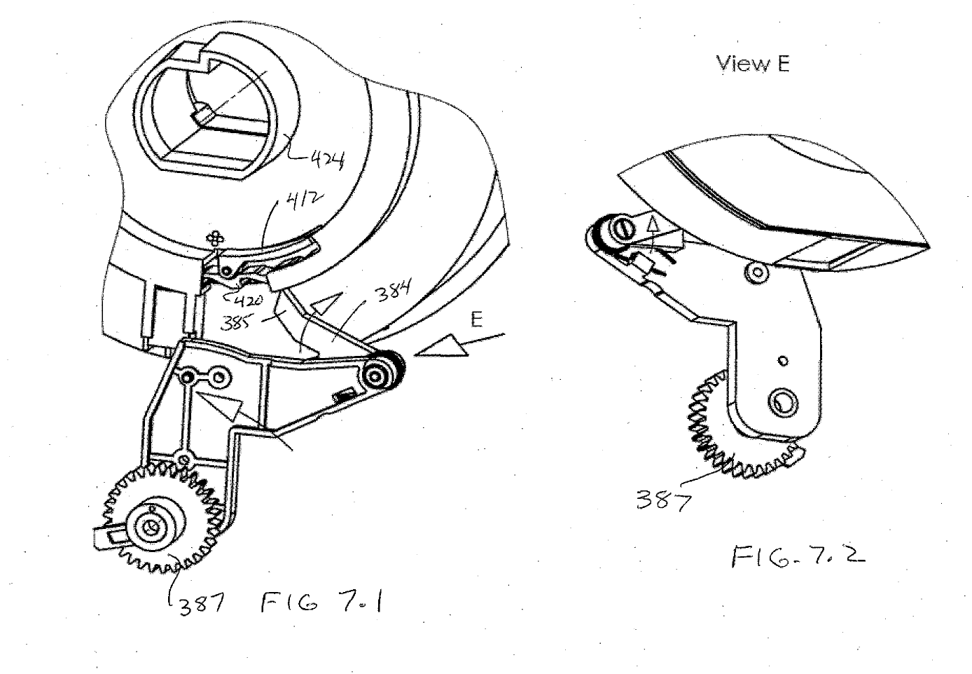

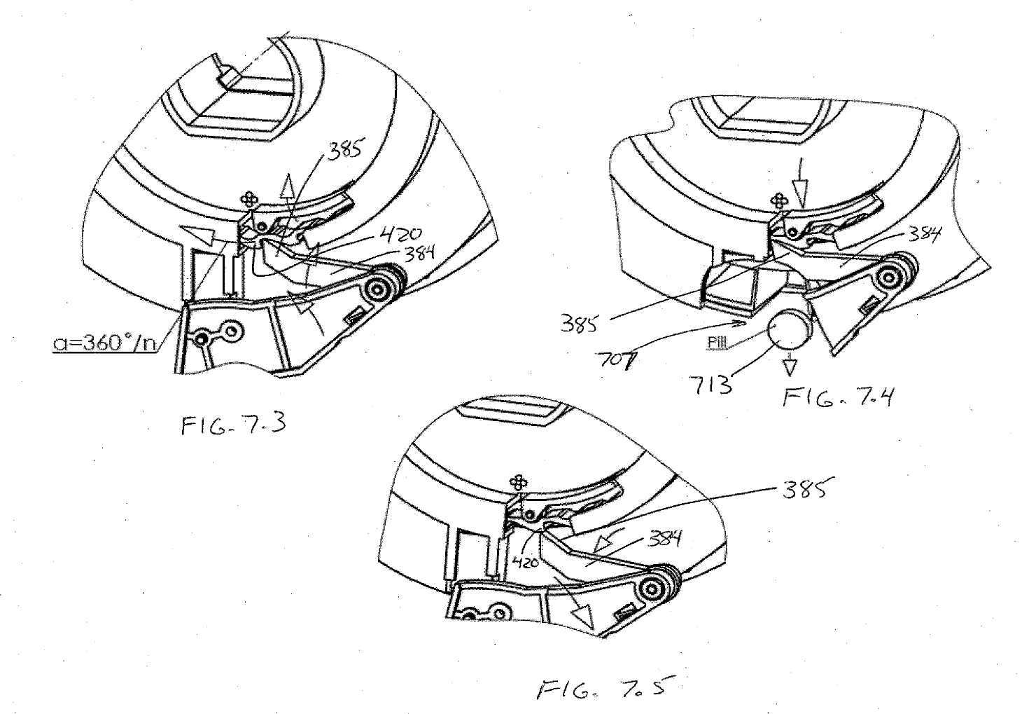

The displaceable arm 380 also serves a different function, namely to cause indexing of the medication drum 404 within the cassette and independent of the rotary shaft. In this case the rotary shaft is returned to the home position and the medication drum is indexed as the front cover is held stationary by the rotary shaft. This aspect can be appreciated from a review of FIGS. 7.1, 7.2, 7.3, 7.4 and 7.5.

As previously discussed, the spring arm 412 and the stop portion 414 cooperate with the series of alignment pockets 418 provided on the ring 416 of the medication drum 404. The ring 416 is fixed on the drum and the interior of the ring forms a series of aligned locations that define indexing locations. The displaceable arm 380 includes a drive arm 384 that is spring biased at one end of the displaceable arm 380. This arm includes an outwardly bent portion 385 used to engage the ratchet teeth 420 provided on the ring 416. The displaceable arm 380 is movable from a position clear of the medication cassette within the movable carrier to an extended position for driving of the ring 416 by engaging the ratchet teeth 420.

The rotation of the displaceable arm is controlled by the drive gear 387 and associated motor 388 mounted on the movable carriage. Rotation of the motor is controlled or measured by the incremental disk 389. The movement of the displaceable arm 380 from a clear position to a position causing indexing of the drum, is shown in FIG. 13. The clear position is shown in solid lines and the indexed position of the drum is shown in dashed lines. The spring bias of the drive arm 384 allows the arm to be retracted and to pass by the back face of a drive tooth. This aspect is shown in FIG. 7.5.

The initial indexing of the medication drum aligns the first cell with the bottom opening provided in the front cover 402 of the medication cassette. Due to gravity the pill 713 shown in FIG. 7.5 falls through the opening 707 and into the medication vessel supported on the carriage.

With this arrangement the carriage is movable beneath the medication cassettes and each medication cassette can be separately indexed to dispense medication according to a particular regime. For example, the dispenser can effectively move the carriage and index the particular cassette for dispensing of medication needed at a particular time. This could be “morning” medication and requires three pills from three of the cassettes. The carriage is appropriately indexed to each appropriate cassette, the medication drum is indexed by the displaceable arm arrangement, and medication falls into the medication vessel provided on the carriage. This “morning” medication can then be provided to the user by moving the carriage to the far end and outputting the medication vessel to the user as shown in FIG. 12. A new medication vessel can be placed in the dispenser or the medication can be removed from the container and returned to the carriage.

The present invention provides a medication cassette that is cost effective to manufacture and is suitable as a disposable package. The medication cassette in combination with the dispensing apparatus allows accurate evaluation of the medication contained within multiple cassettes. Various RFID tags or other tags can be associated with the particular medication cassette to identify the medication of a particular user, the dispensing regime and cassette particulars. A series of cassettes can be loaded for different medications of a particular user or for medications of one or more additional users.

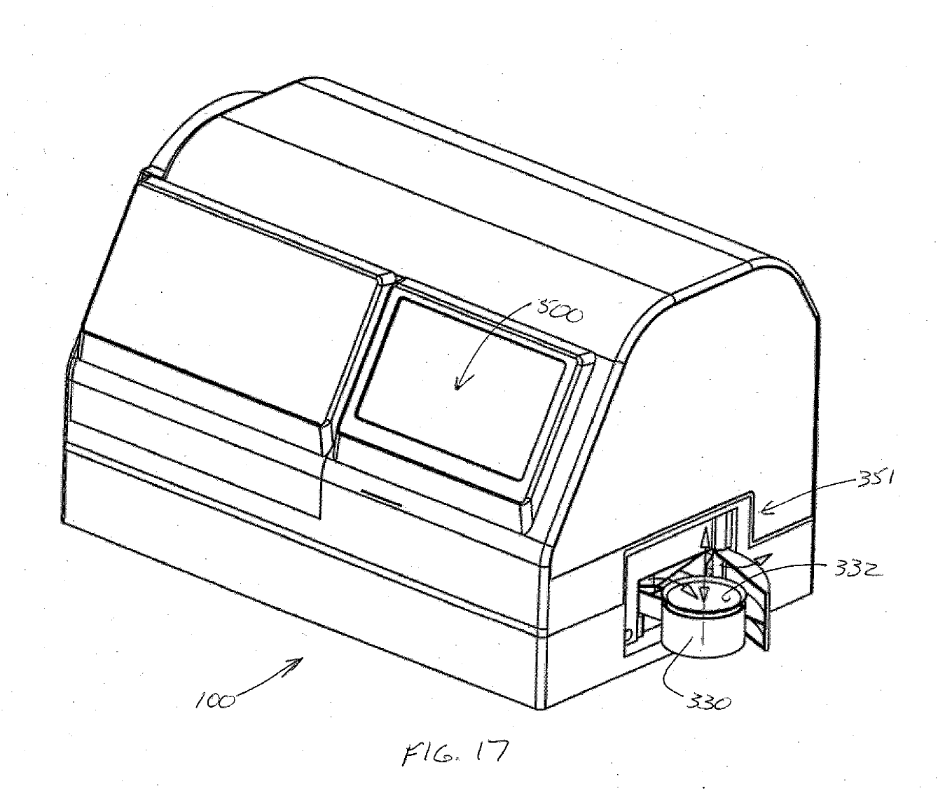

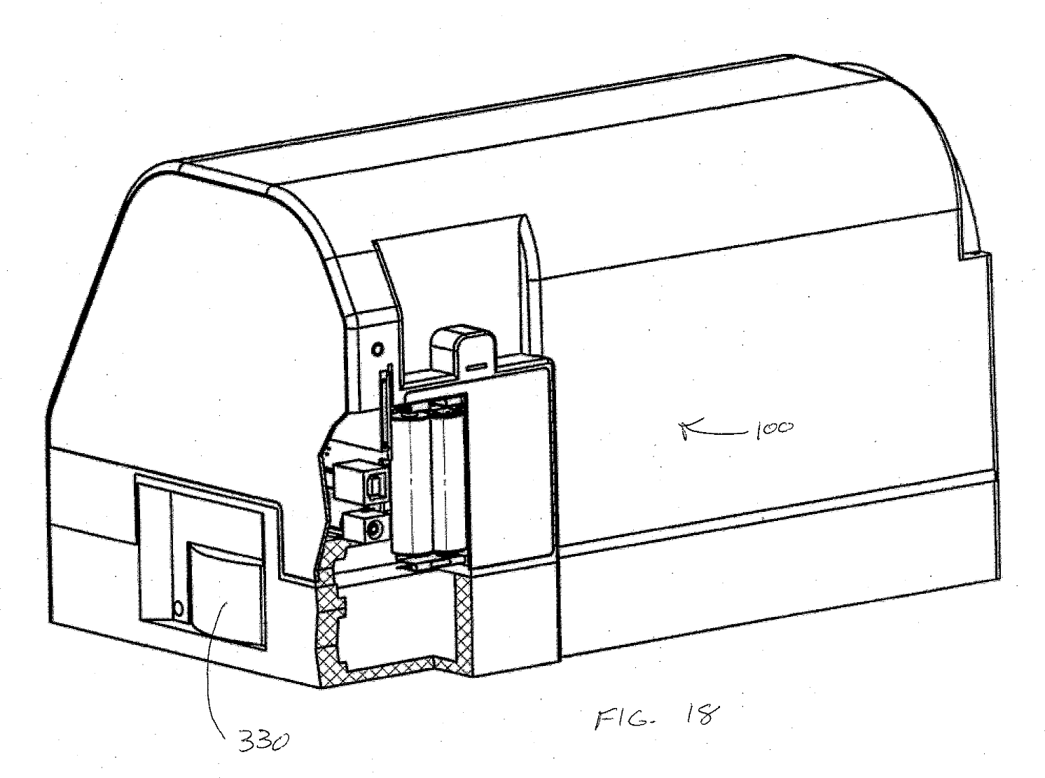

FIG. 17 illustrates how the carriage 300 has moved to one end of the device and shifted the medication receiving vessel through the end port 351. The user can then receive his medication and the device is ready to dispense medication for a different user or for the same user at a later point.

The present invention also includes the dispensing apparatus that receives the cassettes and controls the cassettes to dispense the medication in a particular manner.

The dispensing apparatus preferably tracks user information and test results to provide a detailed history. The tracking of medication that has actually been dispensed as well as the particular conditions of a user over time is of assistance to both the user and his medical advisors regarding the effectiveness of his medical treatment and to also identify any condition changes that may occur.

FIGS. 19 through 24 show a variation of the invention wherein the medication dispensing apparatus includes a series of user fillable cassettes where medication can be appropriately added to the cassettes for future dispensing.

In FIG. 19 the medication dispensing apparatus 100 has been inverted and placed in a support cradle 500. The medication dispensing apparatus is now stably supported with the top surface of the medication dispensing apparatus facing downwardly. The bottom surface 151 of the medication dispensing apparatus 100 now faces upwardly with the upwardly opening loading slot 502 exposed. In this configuration the retainer 330 provided on the movable carriage 300, is partially exposed below the dispensing slot 502 and an aperture provided in this retainer is sized to appropriately receive the loading funnel 504.

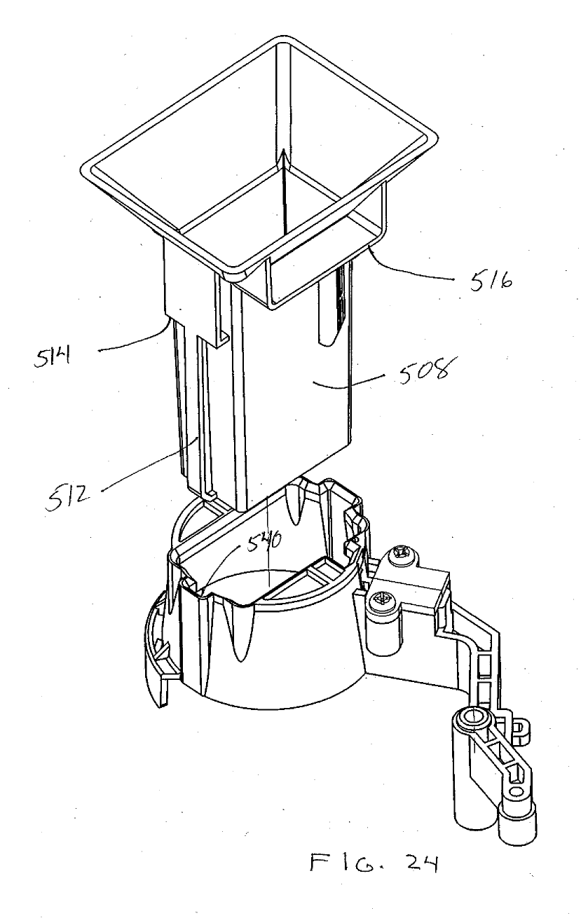

The loading funnel 504 includes an open mouth 506 for receiving medication with the medication passing downwardly through the chute 502 to pass out the open end 510. The lower portion of the chute 508 is received within an opening in the retainer 330 which normally supports a medication vessel 332 when the apparatus is stored in its normal dispensing orientation. In the inverted loading orientation, the bottom portion of the retainer 330 includes an opening that is appropriately shaped to engage the lower portion of the chute 508. This can be appreciated from a review of FIG. 24. As can be seen the loading funnel 504 includes a guide lug 512 that is received in the guide slot 540 of the retainer 330.

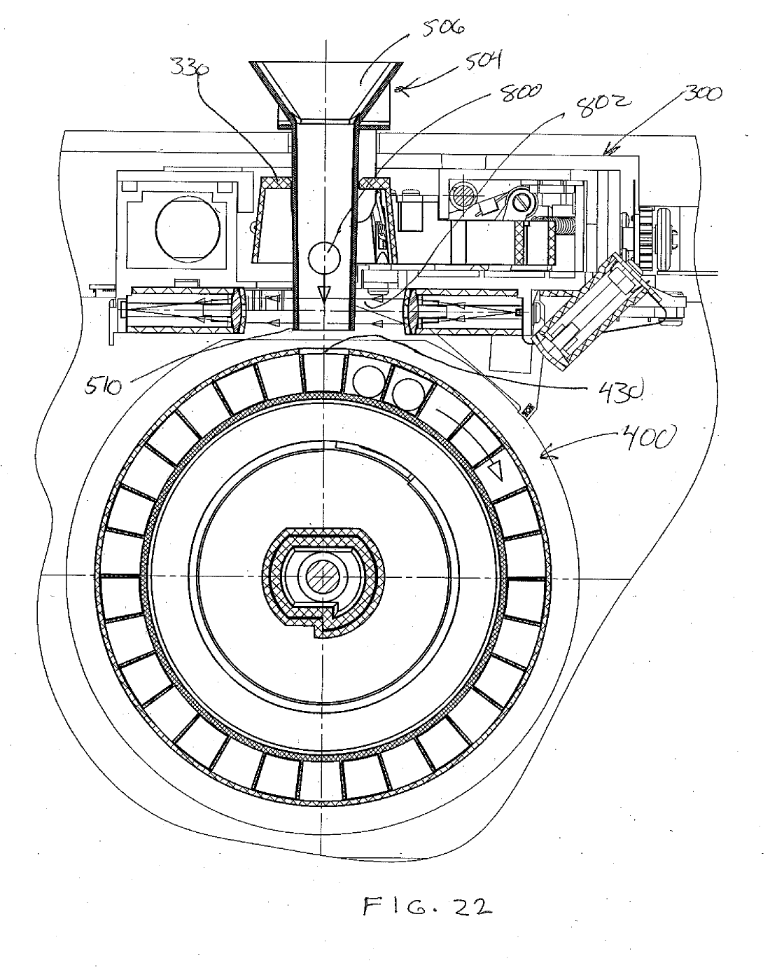

FIG. 22 shows the loading funnel 504 fully received in the retainer 330 and the lower portion of the chute 508 is directly exposed above an opening cell of the medication cassette 400. The port in the outer wall of the cassette 400 through which medication is normally dispensed is shown as 430. Due to the inversion of the medication dispensing apparatus this cell is now upwardly opening and aligned with the chute 408 of the loading funnel 504. The loading funnel 504 preferably includes a translucent lower portion such that medication that is loaded into the cassette can be detected as shown in FIG. 22. In this case the medication 800 is about to interrupt the light beams 802 and interruption of the light beams confirms that a pill has been loaded into the open cell. Once this has occurred the drum of the cassette is indexed by turning clockwise as shown in FIG. 22 to bring the next cell in line with the opening 430. In this way medication can be loaded into each cell of the medication drum with confirmation that the medication has been loaded.

The detecting arrangement for determining whether a pill has been loaded in the appropriate cell is the same sensing arrangement that when the apparatus is inverted, confirms that medication has been dispensed from a particular cell, with both loading and dispensing pills passing by gravity to or from the cassette.

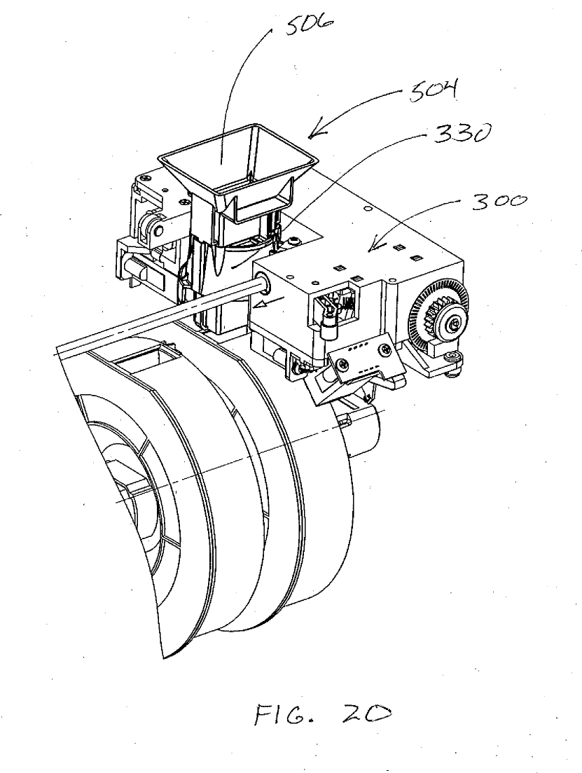

As shown in the partial perspective view of FIG. 20, the carriage 300 that appropriately positioned a medication vessel beneath the cassettes for receiving medication in a particular manner, due to the inversion of the apparatus, is now above the cassettes and is used for positioning of the funnel over any of the medication cassettes. The inversion of the apparatus in cooperation with the cassette design turns the dispensing operation into a loading operation.

With the embodiment as shown in FIGS. 19 through 24, the medication dispensing apparatus is turned upside down and the carriage 300, rather than moving beneath the medication cassettes and receiving medication dropping by gravity from an opening in the cassettes into a medication vessel supported on the carriage, is now positioned above the medication cassettes and selectively aligns a loading funnel with any of the cassettes for loading of medication. The same alignment and sensing arrangement that initially sensed that medication was being dispensed from a cassette is now used to confirm that medication has passed through the chute and loaded into the cassette and the sensing arrangement that was used to confirm that there is medication in a particular cell of the cassette is now used to again confirm that medication has been loaded into that particular cell.

With this arrangement a user or health care provider such as a son or daughter can, from time to time, load the cassettes contained within the dispensing apparatus for future use by the patient. Basically this simplifies the loading of the medication and also allows medication to be loaded for an extended period of time. Once the various medications have been loaded it is quite convenient for the apparatus to dispense the daily medication or the medication required at particular periods of time throughout the day.

It can also be appreciated that the bottom loading slot can have appropriate covers for the slot when not in use. In some cases it may be desirable to leave the slot open.

The dispensing apparatus is described with respect to tracking of dispensed medication preferably in combination with test information to provide a better health record. The loading of medication can also be tracked as well as to confirm appropriate loading of specific cassettes. This is helpful with respect to multiple users receiving dispensed medication.

Although various preferred embodiments of the present invention have been described herein in detail; it will be appreciated by those skilled in the art, that variations may be made thereto without departing from the invention as defined in the appended claims.

The embodiments of the invention in which an exclusive property or privilege is claimed are defined as follows:

1. A medication cassette comprising a front facing cover, a rotatable medication drum and a rear cover;
said medication drum including a series of outwardly opening medication receiving cells;
said front facing cover and said rear cover cooperating with said medication drum to close said cells such that each cell in cooperation with said covers defines a normally closed medication receiving pocket; said medication drum further including a drive arrangement exteriorly accessible for rotating said medication drum within said front facing cover past a dispensing port through which medication in a cell aligned with said dispensing port can pass and be dispensed; said cassette further including an alignment arrangement that holds said medication drum in an aligned position until rotated by drive arrangement.

2. A medication cassette as claimed in claim 1 wherein said drive arrangement is a drive ring generally coaxial with a rotary axis of said medication drum.

3. A medication cassette as claimed in claim 2 wherein said drive ring is generally interior to said cassette and includes an access point for engagement with a drive of a dispensing device.

4. A medication cassette as claimed in claim 3 wherein said drive ring includes outwardly facing drive teeth for incrementally rotating said medication drum.

5. A medication cassette as claimed in claim 1 wherein said alignment arrangement includes a series of aligned positions on an inwardly facing surface of said drive ring and said alignment arrangement includes a displaceable member movable from an aligned position in one of said aligned positions limiting rotation of said medication drum to a release position allowing rotation of said medication drum and wherein said displaceable member is biased to one of said aligned positions.

6. A medication cassette as claimed in claim 5 wherein said displaceable member includes a locking surface biased by a spring arm for engagement with any one of said aligned positions.

7. A medication cassette as claimed in claim 6 wherein said locking surface is a roller secured at an end of said spring arm and said aligned positions are a series of alignment pockets where each pocket is shaped to receive said roller and limit said medication drum against rotation.

8. A medication cassette as claimed in claim 7 wherein each alignment pocket includes cam surfaces on either side thereof linking the pocket with an adjacent pocket.

9. A medication cassette as claimed in claim 1 wherein each of said medication receiving cells are open at an outer radial end thereof.

10. A medication cassette as claimed in claim 1 including a light reflecting surface associated with each cell disposed to reflect light and direct the reflected light through the respective cell and wherein each cell and the cassette allows reflected light to pass out of the cell and the cassette through a radial end of each cell.

11. A medication cassette as claimed in claim 10 wherein said light reflecting surface is conical and has an angle of approximately 45° relative to said cells.

12. A medication cassette as claimed in claim 11 wherein said light reflecting surface is part of said rear cover.

13. A medication cassette as claimed in claim 3 wherein said drive ring projects outwardly from a side of said medication drum and said front cover includes a U shaped recess for covering said drive ring.

14. A medication cassette as claimed in claim 3 wherein said limiting arrangement includes a series of alignment positions on an inwardly facing surface of said drive ring and said limiting arrangement includes a displaceable limiting member movable from an aligned position in one of said alignment positions limiting rotation of said medication drum to a position allowing rotation of said medication drum and wherein said displaceable member is biased to said aligned position and said displaceable member includes a locking surface biased by a spring arm for engagement with any one of said alignment positions; and wherein said drive ring projects outwardly from a side of said medication drum and said front cover includes a ‘U’ shaped recess for covering said drive ring either side thereof and said displaceable member is an integral part of said front facing cover.

15. A medication dispensing and tracking device comprising a rotary shaft supported at one end thereof and connected to a rotary drive engaging and rotating said rotary shaft with operation of said rotary drive; said rotary shaft having a free end and being of a length to receive thereon at least 3 separate medication cassettes; said cassettes engaging said rotary shaft and rotating with rotation of said rotary shaft; said dispensing and tracking device including a movable carriage located below said shaft and movable in a direction parallel to and along said rotary shaft to positions aligned with different cassettes secured on said rotary shaft; said carriage when aligned with a cassette receiving medication dispensed from said cassette by gravity; said dispensing and tracking apparatus including a medication detecting arrangement movable between the cassettes and movable with the movable carriage, said medication detecting arrangement being in position to detect medication as it is dispensed from a cassette and received by said movable carriage.

16. A medication dispensing and tracking device as claimed in claim 15 wherein said medication detecting arrangement is mounted on said carriage and movable therewith.

17. A medication dispensing and tracking device as claimed in claim 16 wherein said medication detecting arrangement is an optical beam type detecting arrangement having a spaced transmitter and receiver located such that dispensed medication passes between said spaced transmitter and receiver and interrupts a transmitted beam.

18. A medication dispensing and tracking device as claimed in claim 15 wherein said device includes a cassette medication loading position allowing medication to be loaded into any cassettes secured on said rotary shaft; said cassette medication loading position requiring inversion of said device to position said carriage above said cassettes; said carriage in said cassette medication loading position receiving a loading funnel through which medication can be loaded into an aligned cassette through a port in the cassette normally used to dispense medication.

19. A medication dispensing and tracking device as claimed in claim 18 wherein said device includes an upwardly opening slot and said funnel is movable along said slot with movement of said carriage.

20. A medication dispensing and tracking device as claimed in claim 15 wherein said device includes a first support surface supporting said device in a medication dispensing orientation with said carriage beneath said cassettes and a second support surface supporting said device in a medication loading orientation with said carriage generally above said cassettes for gravity loading of medication through said carriage into any one of the cassettes aligned with said carriage.

21. A medication dispensing and tracking device as claimed in claim 20 wherein said carriage includes a pass through port and a loading funnel releasably received in said pass through port for loading of medication into one of said cassettes aligned with said pass through port.
